(19) United States
(12) Patent Application Publication
(10) Pub. No.: US 2015/0362637 A1
(43) Pub. Date: Dec. 17, 2015

(54) ELECTRO-OPTICAL DEVICE AND ELECTRONIC APPARATUS

(71) Applicant: Seiko Epson Corporation, Tokyo (JP)

(72) Inventor: Hirotaka KAWATA, Suwa-shi (JP)

(21) Appl. No.: 14/764,549

(22) PCT Filed: Jan. 28, 2014
(86) PCT No.: PCT/JP2014/000434

§ 371 Date: Jul. 29, 2015

(30) Foreign Application Priority Data
Feb. 5, 2013 (JP) 2013-020162

(51) Int. Cl. G02B 3/00; G02B 27/00; G02B 5/20

(52) U.S. Cl. CPC G02B 3/0043; G02B 3/0056; G02B 5/201; G02B 27/0025

(57) ABSTRACT

An electro-optical device 100 includes a plurality of pixels 50. The plurality of pixels 50 include a pixel of green 50G having a color filter 11G selectively transmitting green light, a liquid crystal device 30 modulating an irradiation light, and a microlens 26G condensing the irradiation light traveling toward the liquid crystal device 30 and a pixel of red 50R having a color filter 11R selectively transmitting red light, a liquid crystal device 30 modulating an irradiation light, and a microlens 26R condensing the irradiation light traveling toward the liquid crystal device 30, in which an image forming point 26G of the microlens to green light and an image forming point 26R of the microlens to red light are positioned within a plane surface (P0) parallel to an array surface of the plurality of pixels 50.

### TECHNICAL FIELD

The present invention relates to a technology of displaying an image utilizing a plurality of pixels.

### BACKGROUND ART

A technology of condensing an irradiation light emitted from a light source device by a microlens for each pixel, is proposed in the related art. For example, in PTL 1, a liquid crystal panel in which the irradiation light condensed by the microlens (a condensing body) for each pixel is transmitted through a color filter of each display color and a liquid crystal device and an image is displayed, is disclosed.

### CITATION LIST

### Patent Literature

PTL 1: Japanese Unexamined Patent Application Publication No. 2002-189216

### SUMMARY OF INVENTION

### Technical Problem

By the way, the focal distance of the microlens differs in accordance with a wavelength of an incident light. Therefore, in a configuration of PTL 1 in which the light condensing characteristics of the microlens are common regardless the display color of each pixel, the focal distance (an image forming position or a beam angle) to each color light transmitted through the color filter of each pixel differs for each display color and, as a result, there is a problem that the display quality of a color image deteriorates (chromatic aberration). An advantage of some aspects of the invention is to suppress the deterioration of display quality due to the difference in the focal distance of a condensing body for each display color.

### Solution to Problem

In order to such problems, according to a first aspect of the invention, there is an electro-optical device including a plurality of pixels arrayed in a plane shape, in which the plurality of pixels include a first pixel having a first color filter selectively transmitting an irradiation light of a first wavelength, a first electro-optical element modulating the irradiation light, and a first condensing body condensing the irradiation light traveling toward the first electro-optical element and a second pixel having a second color filter selectively transmitting an irradiation light of a second wavelength which is different from the first wavelength, a second electro-optical element modulating the irradiation light, and a second condensing body condensing the irradiation light traveling toward the second electro-optical element, and an image forming point of the first condensing body to the irradiation light of the first wavelength and an image forming point of the second condensing body to the irradiation light of the second wavelength are positioned within a plane surface parallel to an array surface of the plurality of pixels. In the configuration described above, since the image forming point of the first condensing body to the irradiation light of the first wavelength and the image forming point of the second condensing body to the irradiation light of the second wavelength are positioned within a plane surface parallel to the array surface of the plurality of pixels, the deterioration of display quality due to the difference in the focal distance of the condensing body for each display color is suppressed.

In the preferable aspect of the invention, a focal distance of the first condensing body to the first wavelength is the same as a focal distance of the second condensing body to the second wavelength. In the configuration described above, since the focal distance of the first condensing body to the first wavelength is the same as the focal distance of the second condensing body to the second wavelength, the deterioration of display quality due to the difference in the focal distance of the condensing body for each display color is suppressed. Meanwhile, in the invention, the focal distance of the first condensing body is the same as the focal distance of the second condensing body which means that both focal distances are substantially the same. That is, a case where the focal distance of the first condensing body does not conform completely to the focal distance of the second condensing body due to, for example, an error in manufacturing is also included in a range of “the same” of the invention as long as it is within a range in which the deterioration of display quality due to the difference in the focal distance of each condensing body is suppressed.

In the preferable aspect of the invention, the plurality of pixels include a third pixel which has a third electro-optical element modulating while light and a third condensing body condensing the irradiation light traveling toward the third electro-optical element and emits white light after the modulation by the third electro-optical element, the first color filter selectively transmits green light, and a focal distance of the first condensing body is the same as a focal distance of the third condensing body. In the configuration described above, since the plurality of pixels includes the third pixel which emits white light, the utilization efficiency of the irradiation light is enhanced, compared to a configuration in which a pixel which emits white light is not included. In addition, since the focal distance of the third condensing body to green light is the same as the focal distance of the first condensing body to green light, it is possible to suppress the deterioration of display quality due to the difference in the focal distance of the condensing body for each pixel, for example, compared to a configuration in which the focal distance of the third condensing body to green light is set to being the same as the focal distance of the second condensing body to the irradiation light of the second wavelength.

In the preferable aspect of the invention, the second color filter selectively transmits the irradiation light of the second wavelength which is longer than the first wavelength and a curvature of the second condensing body is greater than a curvature of the first condensing body. In the configuration described above, since the curvature of the second condensing body is greater than the curvature of the first condensing body, the difference between the focal distance of each condensing body of the first pixel and the focal distance of each condensing body of the second pixel is reduced. Therefore, the deterioration of display quality due to the difference in the focal distance of the condensing body for each display color is suppressed.

In the preferable aspect of the invention, the second color filter selectively transmits the irradiation light of the second wavelength which is longer than the first wavelength and a refractive index of the second condensing body is higher than a refractive index of the first condensing body. In the configuration described above, since the refractive index of the second condensing body is higher than the refractive index of the first condensing body, the difference between the focal distance of each condensing body of the first pixel and the focal distance of each condensing body of the second pixel is reduced. Therefore, the deterioration of display quality due to the difference in the focal distance of the condensing body for each display color is suppressed.

The electro-optical device according to each aspect described above is applied to various kinds of electronic apparatuses. For example, a projection type display apparatus which projects an image onto a projection surface by modulating the irradiation light from the light source device for each pixel is assumed as a preferable example of an electronic apparatus according to the invention.

According to a second aspect of the invention, there is an electro-optical device including a plurality of pixels arrayed in a plane shape, in which the plurality of pixels include a first pixel having a first color filter selectively transmitting an irradiation light of a first wavelength, a first electro-optical element modulating the irradiation light, and a first condensing body condensing the irradiation light traveling toward the first electro-optical element and a second pixel having a second color filter selectively transmitting an irradiation light of a second wavelength which is longer than the first wavelength, a second electro-optical element modulating the irradiation light, and a second condensing body condensing the irradiation light traveling toward the second electro-optical element, and a curvature of the second condensing body is greater than a curvature of the first condensing body. In the configuration described above, since the curvature of the second condensing body is greater than the curvature of the first condensing body, the difference between the focal distance of each condensing body of the first pixel and the focal distance of each condensing body of the second pixel is reduced. Therefore, the deterioration of display quality due to the difference in the focal distance of the condensing body for each display color is suppressed.

According to a third aspect of the invention, there is an electro-optical device including a plurality of pixels arrayed in a plane shape, in which the plurality of pixels include a first pixel having a first color filter selectively transmitting an irradiation light of a first wavelength, a first electro-optical element modulating the irradiation light, and a first condensing body condensing the irradiation light traveling toward the first electro-optical element and a second pixel having a second color filter selectively transmitting an irradiation light of a second wavelength which is longer than the first wavelength, a second electro-optical element modulating the irradiation light, and a second condensing body condensing the irradiation light traveling toward the second electro-optical element, and a refractive index of the second condensing body is higher than a refractive index of the first condensing body. In the configuration described above, since the refractive index of the second condensing body is higher than the refractive index of the first condensing body, the difference between the focal distance of each condensing body of the first pixel and the focal distance of each condensing body of the second pixel is reduced. Therefore, the deterioration of display quality due to the difference in the focal distance of the condensing body for each display color is suppressed.

### BRIEF DESCRIPTION OF DRAWINGS

FIG. 1 is a plane view illustrating an array of a plurality of pixels in an electro-optical device.

FIG. 2 is a cross-section view of the electro-optical device.

FIG. 3 is a view illustrating a configuration of a microlens in Comparative Example.

FIG. 4 is a view illustrating a configuration of a microlens in a first embodiment.

FIG. 5 is a plane view illustrating an array of a plurality of pixels in a second embodiment of the invention.

FIG. 6 is a cross-section view of an electro-optical device in a second embodiment.

FIG. 7 is a cross-section view of an electro-optical device in a third embodiment.

FIG. 8 is a view explaining a configuration of a microlens in Modification Example of the invention.

FIG. 9 is a configuration view of a projection type display apparatus which is an example of an electronic apparatus according to the invention.

### DESCRIPTION OF EMBODIMENTS

### First Embodiment

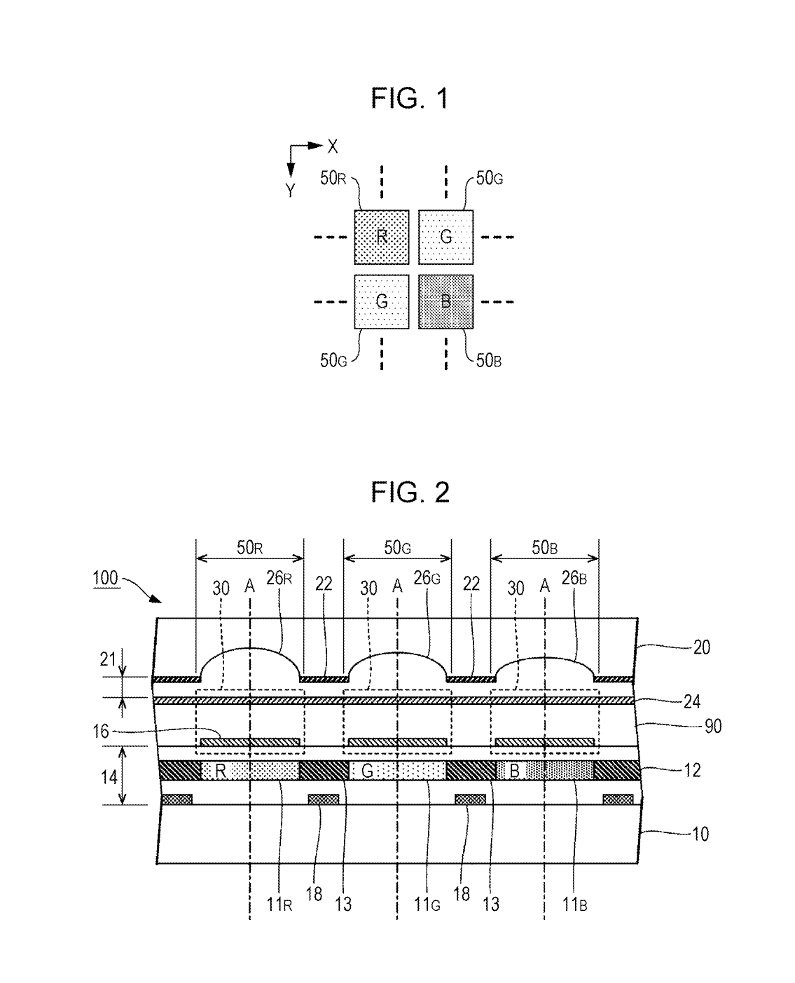

As shown in FIG. 1, an electro-optical device 100 of a first embodiment of the invention includes a plurality of pixels 50 (50R, 50G, and 50B) which are arrayed in a plane shape (in a matrix shape) along an X direction and a Y direction intersecting with each other. In the plurality of pixels 50, the pixel 50R displaying red (R), the pixel 50G displaying green (G), and the pixel 50B displaying blue (B) are included. The pixels 50 of each display color are arrayed in a Bayer array.

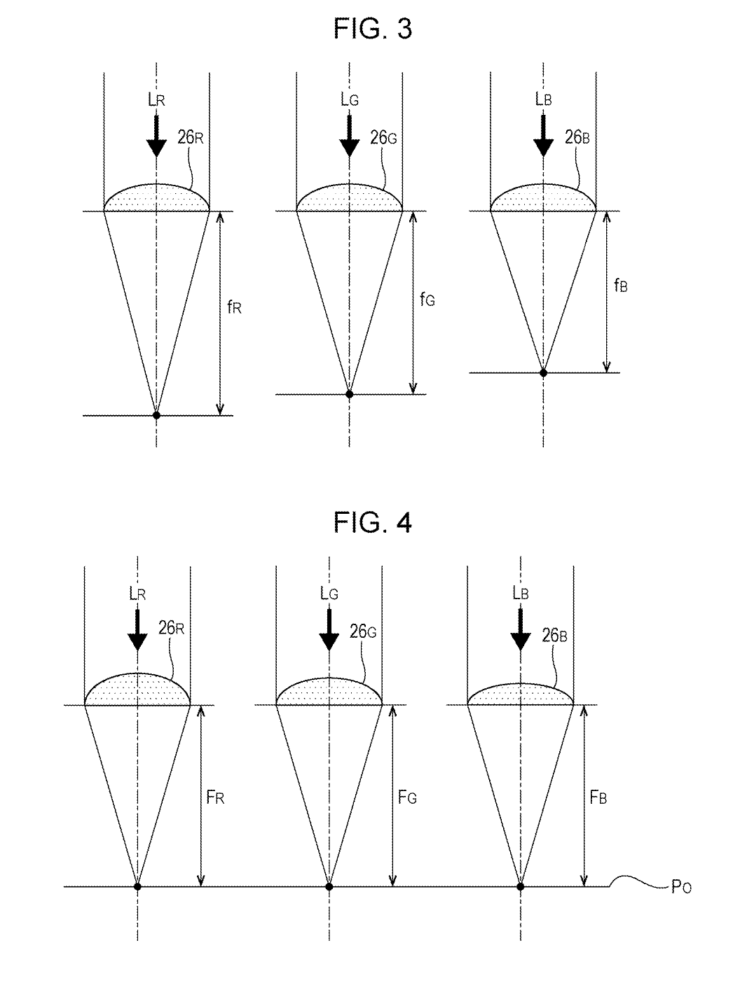

FIG. 2 is a cross-section view of the electro-optical device 100 in the embodiment. The electro-optical device 100 is configured by including a first substrate 10 and a second substrate 20 which face each other at a predetermined interval and a liquid crystal 90 filled in a space between the first substrate 10 and the second substrate 20. The irradiation light (the white light) emitted from the light source device (not shown) enters into the electro-optical device 100 from the second substrate 20 side.

The first substrate 10 is a translucent plate-like member formed of a glass, quartz, or the like. A wiring layer 14 is formed on the surface of the liquid crystal 90 side of the first substrate 10 and a plurality of pixel electrodes 16 are formed on the surface of the wiring layer 14. The wiring layer 14 is configured by including a filter layer 12, a plurality of thin film transistors (TFT) 18, and various kinds of wirings (a data line and a scanning line). Each TFT 18 is a switching element which is electrically connected to each pixel electrode 16.

The filter layer 12 is configured by including a plurality of color filters 11 (11R, 11G, and 11B) and a light shielding layer 13. The plurality of color filters 11 are formed for each pixel 50 and correspond to any of plurality of display colors which are different from each other (red, green, and blue). The color filter 11R corresponding to the pixel 50R of red selectively transmits red light of a wavelength (a representative wavelength is 620 nm) corresponding to red (R) among the irradiation light. In the same way, the color filter 11G corresponding to the pixel 50G of green selectively transmits green light (a representative wavelength is 530 nm) and the color filter 11B corresponding to the pixel 50B of blue selectively transmits blue light (a representative wavelength is 450 nm). For example, the color filter 11 is formed of a translucent resin material in which a color material such as a pigment is dispersed. The light shielding layer 13 is a light-shielding (properties of absorbing and reflecting light) film body defining an outer edge of each color filter 11.

Each pixel electrode 16 shown in FIG. 2 is individually formed of, for example, a translucent conductive material such as indium tin oxide (ITO) on the surface of the wiring layer 14 for each pixel 50 and is arrayed in a matrix shape so as to overlap with each color filter 11 in plane view. Meanwhile, actually, an element such as an oriented film covering each pixel electrode 16 is also formed, however, an illustration thereof was conveniently omitted in FIG. 2.

The second substrate 20 in FIG. 2 is a translucent plate-like member formed of a glass, quartz, or the like. A microlens array 21 is formed on the surface of the liquid crystal 90 side of the second substrate 20. The microlens array 21 is configured by including a plurality of microlenses 26 (26R, 26G, and 26B) corresponding to each pixel 50 and a light shielding layer 22 shielding light between each microlens 26. Each microlens 26 is a condensing body condensing the irradiation light. The microlens 26R corresponding to the pixel 50R of red is formed at the position which is overlapped with the color filter 11R in plane view. In the same way, the microlens 26G overlaps with the color filter 11G and the microlens 26B overlaps with the color filter 11B. In the embodiment, each refractive index of the microlens 26R, the microlens 26G, and the microlens 26B is common. The light shielding layer 22 is a light-shielding film body.

A counter electrode 24 is formed on the surface of the microlens array 21. The counter electrode 24 is continuously formed of, for example, a translucent conductive material such as ITO over substantially the entire surface of the second substrate 20. In the embodiment, as shown in FIG. 2, a liquid crystal device 30 including the pixel electrode 16 and the counter electrode 24 facing each other and the liquid crystal 90 between both electrodes, is configured for each pixel 50. The transmittance (the display gradation) of the irradiation light in the liquid crystal device 30 is changed by controlling the orientation of the liquid crystal 90 in accordance with an applied voltage between the pixel electrode 16 and the counter electrode 24. That is, the liquid crystal device 30 functions as an element modulating the irradiation light (an electro-optical element in which the optical characteristics are changed in accordance with an electric action).

As described above, the plurality of pixels 50 are respectively configured by including the color filter 11, the microlens 26, and the liquid crystal device 30. As shown in FIG. 2, in one pixel 50, the color filter 11 and the liquid crystal device 30 are arranged on an optical axis A of the microlens 26.

In FIG. 3, a configuration in which the shape of the microlens 26 (26R, 26G, and 26B) corresponding to each display color is set to be common, is disclosed as Comparative Example. The focal distance of each microlens 26 differs in accordance with the wavelength of an incident light. Therefore, in Comparative Example in which the shape of each microlens 26 is common, the focal distance f (fR, fG, and fB) of the each microlens 26 to color light utilized for displaying by each pixel 50, differs for each display color of each pixel 50 (fR≠fG≠fB). Specifically, the focal distance fR of the microlens 26 to red light LR is longer than the focal distance fG of the microlens 26 to green light LG and the focal distance fG of the microlens 26 to green light LG is longer than the focal distance fB of the microlens 26 to blue light LB. In Comparative Example, the deterioration (chromatic aberration) of display quality due to the difference in the focal distance as explained above becomes a problem.

In consideration of circumstances described above, in the first embodiment of the invention, as shown in FIG. 4, the shape of the microlens 26 of each pixel 50 is made different for each display color. Specifically, the curvature κ of the microlens 26 is made different for each display color of each pixel 50 so as to reduce the difference in the focal distance for each display color. In consideration of a trend in which the bigger the curvature κ of the microlens 26 is, the shorter the focal distance of the microlens 26 is, in the first embodiment, the curvature κR of the microlens 26R is greater than the curvature κG of the microlens 26G and the curvature κG of the microlens 26G is greater than the curvature κB of the microlens 26B (κR>κG>κB). Specifically, the curvature κ of each microlens 26 is selected for each display color so that the focal distance FR of the microlens 26R to red light LR, the focal distance FG of the microlens 26G to green light LG, and the focal distance FB of the microlens 26B to blue light LB become substantially the same. Therefore, the image forming point of the microlens 26 (each pixel 50) corresponding to each display color is positioned within a plane surface P0 shown in FIG. 4. The plane surface P0 is a plane surface parallel to a plane surface (an X-Y plane surface) on which the plurality of pixels 50 are arrayed and can be also reworded as a plane surface parallel to the first substrate 10 or the second substrate 20.

As explained above, in the first embodiment, the shape (the curvature κ) of each microlens 26 is individually selected for each display color of the pixel 50 so as to reduce the difference in the focal distance of the microlens 26 to color light of the display color of each pixel 50. Therefore, the deterioration of display quality due to the difference in the focal distance of the microlens 26 for each display color, is suppressed. In the first embodiment, in particular, the curvature κ of each microlens is selected so that the focal distance of the microlens 26 to color light of each pixel 50 becomes the same. Therefore, an effect capable of suppressing the deterioration of the display quality due to the difference in the focal distance of the microlens 26 for each display color, is particularly remarkable.

### Second Embodiment

A second embodiment of the invention will be described below. Meanwhile, in each configuration exemplified below, as to elements in which an action and a function are the same as those of the first embodiment, sings referred to in the description above are diverted and each detailed description is appropriately omitted.

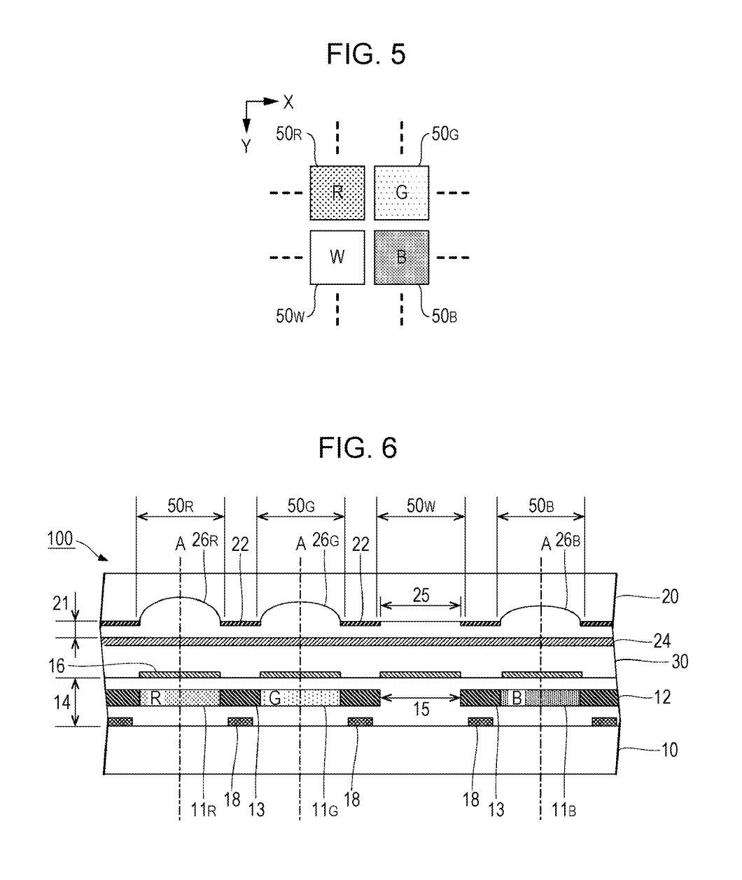

As shown in FIG. 5, in the electro-optical device 100 of the second embodiment, the plurality of pixels 50 which are arrayed in a plane shape (in a matrix shape) along an X direction and a Y direction intersecting with each other include a pixel of white (hereinafter, referred to as a “white pixel”) 50W, in addition to the pixel 50R, the pixel 50G, and the pixel 50B. Specifically, as shown in FIG. 5, one pixel 50G of green among four pixels 50 (FIG. 1) to be a unit of a Bayer array is substituted with the white pixel 50W. According to the configuration described above, it is possible to enhance the brightness of a display image, compared to a configuration without arranging the white pixel 50W.

FIG. 6 is a cross-section view of the electro-optical device 100 in the second embodiment. In the embodiment, an opening portion 15 is formed in a region corresponding to each white pixel 50W of the filter layer 12. That is, in the white pixel 50W, the color filter 11 is omitted. The opening portion 15 transmits the whole components of the irradiation light (white light).

As shown in FIG. 6, a flat portion 25 is formed in a region corresponding to the white pixel 50W of the microlens array 21. That is, the microlens 26 is not formed in the white pixel 50W. The flat portion 25 is provided for each white pixel 50W so as to overlap with the opening portion 15 in plane view. Since the flat portion 25 does not have the curvature, the flat portion 25 does not function as a condensing body condensing the irradiation light.

In the second embodiment, the same effect as that of the first embodiment is also obtained. Meanwhile, white light includes red light, green light, and blue light. Since each color light included in white light is imaged at a different position when white light is condensed in the white pixel 50W by the microlens 26, a problem of the chromatic aberration in the white pixel 50W occurs. In the embodiment, since white light is not condensed in the flat portion 25 of the white pixel 50W, a problem of the chromatic aberration does not occur. Therefore, it is possible to prevent the deterioration of the display quality due to the chromatic aberration in the white pixel 50W.

### Third Embodiment

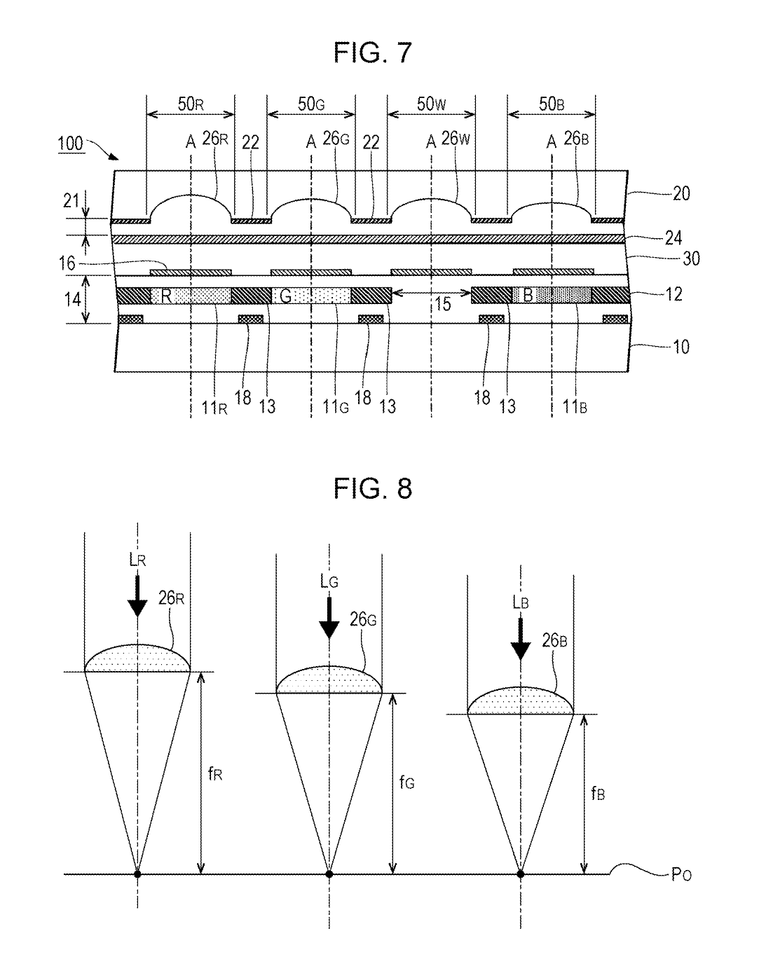

FIG. 7 is a cross-section view of the electro-optical device 100 in a third embodiment. In the third embodiment, in the same way as the second embodiment, the plurality of pixels 50 include the white pixel 50W, in addition to the pixel 50R, the pixel 50G, and the pixel 50B and the opening portion 15 is formed in a region corresponding to each white pixel 50W of the filter layer 12.

As shown in FIG. 7, in the embodiment, the microlens 26W is formed in a region corresponding to the white pixel 50W of the microlens array 21. The microlens 26W is provided for each white pixel 50W so as to overlap with the opening portion 15 in plane view and condenses the irradiation light (white light). The shape of the microlens 26W is a shape in which the curvature κW of the microlens 26W is the same as the curvature κG of the microlens 26G. Therefore, the focal distance of the microlens 26W to green light becomes the same as the focal distance FG of the microlens 26G to green light.

In the third embodiment, the same effect as that of the first embodiment is also obtained. In addition, in the third embodiment, since the microlens 26W is also arranged in the white pixel 50W, it is possible to enhance the utilization efficiency of the irradiation light, compared to the second embodiment in which the microlens 26W is not arranged.

By the way, the human visibility to green light exceeds the visibility to blue light and red light. In the embodiment, since the focal distance of the microlens 26W to green light is the same as the focal distance FG, the focal distance FR, and the focal distance FB, it is possible to suppress the deterioration of the display quality due to the difference in the focal distance of the microlens 26 for each pixel 50, compared to a configuration in which the focal distance of the microlens 26W to red light is made to coincide with that of microlens 26R of red or a configuration in which the focal distance of the microlens 26W to blue light is made to coincide with that of microlens 26B of blue.

### Modification Example

Forms exemplified above can be modified in various ways. Aspects of specific modifications will be exemplified below. Two aspects or more arbitrarily selected from the following exemplifications can be appropriately combined.

(1) In the form described above, while the curvature κ of each microlens 26 is made different for each display color, instead of this, the refractive index of each microlens 26 may be made different for each display color. Specifically, the refractive index of the microlens 26R is set to be higher than the refractive index of the microlens 26G and the refractive index of the microlens 26G is set to be higher than the refractive index of the microlens 26B. Since there is a tendency in which the higher the refractive index of the microlens 26 is, the shorter the focal distance of the microlens 26 is, it is possible to reduce the difference in the focal distance for each microlens 26 to color light of each display color. In the configuration described above, the same effect as that of the first embodiment is obtained. In addition, both of the curvature κ and the refractive index of the microlens 26 may be made different from each other for each display color of each pixel 50 so that the difference in the focal distance for each microlens 26 of each display color is reduced.

(2) As shown in FIG. 8, the shape of microlens of each pixel 50 may be set to be common and the distance from each microlens 26 in each pixel 50 to the plane surface P0 may be made different for each display color. In the configuration shown in FIG. 8, since the shape of microlens 26 of each display color are common, the focal distance fR, the focal distance fG, and the focal distance fB differ from each other. On the other hand, the distance between each microlens 26 in each pixel 50 and the plane surface P0 is set to the focal distance of each microlens 26 to color light of each display color. Specifically, the distance from the microlens 26R to the plane surface P0 is the focal distance fR, the distance from the microlens 26G to the plane surface P0 is the focal distance fG, and the distance from the microlens 26B to the plane surface P0 is the focal distance fB. Therefore, the image forming point of the microlens 26 (each pixel 50) corresponding to each display color is positioned within the plane surface P0 in FIG. 8. According to the configuration described above, in the same way as the first embodiment, it is possible to suppress the deterioration of display quality due to the difference in the focal distance of the microlens 26 for each display color, for example, compared to a configuration in which the distance from each microlens 26 in each pixel 50 to the plane surface P0 is the same in each pixel 50 as Comparative Example shown in FIG. 3.

(3) In each form described above, while the filter layer 12 is formed on the wiring layer 14, the position of the filter layer 12 can be appropriately changed. For example, it is possible to employ a configuration in which the filter layer 12 is formed on the side opposite to the liquid crystal 90 when being viewed from the microlens array 21 or a configuration in which the filter layer 12 is formed between the microlens array 21 and the liquid crystal device 30.

(4) It is also possible to configure the microlens 26 with a plurality of lenses. That is, the microlens 26 in each form described above is comprehensively expressed as an element of condensing the irradiation light (the condensing body) and any structure for realizing the condensation is accepted.

(5) The configuration of the color filter 11 can be appropriately changed. For example, it is also possible to utilize a dielectric multilayer film which selectively emphasizes color light of a specific wavelength by laminating a plurality of light transmission layers (the dielectric layers) in which the refractive indexes are differ from each other as the color filter 11 in each forms described above.

### Application Example

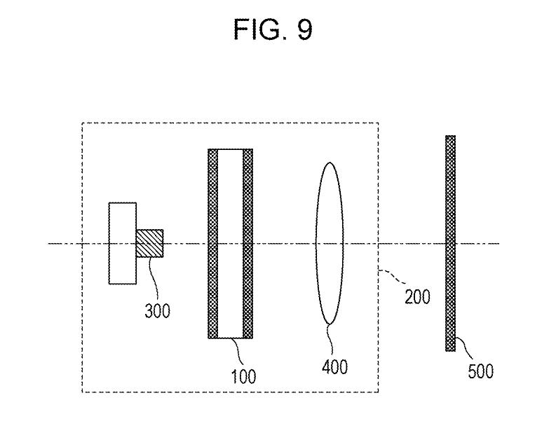

The electro-optical device 100 in each form described above is utilized in various kinds of electronic apparatuses. FIG. 9 is a view illustrating each element of a projection type display apparatus (a projector) 200 utilizing the electro-optical device 100 in each form described above. The projection type display apparatus 200 includes a light source device 300, the electro-optical device 100, and a projection optical system 400. The irradiation light emitted from the light source device 300 is modulated in the electro-optical device 100 and the irradiation light after the modulation is projected onto a projection surface 500 through the projection optical system 400. In the projection type display apparatus 200, the electro-optical device 100 functions as an element (a light valve) modulating the irradiation light in accordance with an image specified by an image signal.

Meanwhile, as an electronic apparatus to which the electro-optical device according to the invention is applied, personal digital assistants (PDA), a digital steel camera, a television, a video camera, a car navigation apparatus, an on-vehicle display apparatus (an instrument panel), an electronic notebook, an electronic paper, a calculator, a word processor, a workstation, a video telephone, a POS terminal, a printer, a scanner, and a copying machine, a video player, an apparatus with a touch panel, and the like are included, in addition to the projection type display apparatus 200 exemplified in FIG. 7.

This application claims priority to Japan Patent Application No. 2013-020162 filed Feb. 5, 2013, the entire disclosures of which are hereby incorporated by reference in their entireties.

1. An electro-optical device comprising:
a plurality of pixels arrayed in a plane shape,
wherein the plurality of pixels include
a first pixel having a first color filter selectively transmitting an irradiation light of a first wavelength, a first electro-optical element modulating the irradiation light, and a first condensing body condensing the irradiation light traveling toward the first electro-optical element, and
a second pixel having a second color filter selectively transmitting an irradiation light of a second wavelength which is different from the first wavelength, a second electro-optical element modulating the irradiation light, and a second condensing body condensing the irradiation light traveling toward the second electro-optical element, and
wherein an image forming point of the first condensing body to the irradiation light of the first wavelength and an image forming point of the second condensing body to the irradiation light of the second wavelength are positioned within a plane surface parallel to an array surface of the plurality of pixels.

2. The electro-optical device according to claim 1,
wherein a focal distance of the first condensing body to the first wavelength is the same as a focal distance of the second condensing body to the second wavelength.

3. The electro-optical device according to claim 1,
wherein the plurality of pixels include a third pixel which has a third electro-optical element modulating while light and a third condensing body condensing the irradiation light traveling toward the third electro-optical element and emits white light after the modulation by the third electro-optical element,
wherein the first color filter selectively transmits green light, and
wherein a focal distance of the first condensing body is the same as a focal distance of the third condensing body.

4. The electro-optical device according to claim 2,
wherein the second color filter selectively transmits the irradiation light of the second wavelength which is longer than the first wavelength, and
wherein a curvature of the second condensing body is greater than a curvature of the first condensing body.

5. The electro-optical device according to claim 2,
wherein the second color filter selectively transmits the irradiation light of the second wavelength which is longer than the first wavelength, and
wherein a refractive index of the second condensing body is higher than a refractive index of the first condensing body.

6. An electronic apparatus comprising:
the electro-optical device according to claim 1.
